(19) United States
(12) Patent Application Publication
(10) Pub. No.: US 2026/0269905 A1
(43) Pub. Date: Sep. 10, 2026

(54) METHOD AND APPARATUS FOR CHANNEL STATE INFORMATION-REFERENCE SIGNAL RESOURCE CONFIGURATION APPLIED TO SUB-BAND FULL DUPLEX IN MOBILE COMMUNICATIONS

(71) Applicant: MediaTek Singapore Pte. Ltd., Singapore (SG)

(72) Inventors: Sumaila Anning MAHAMA, Cambridge (GB); Mohammed S Aleabe AL-IMARI, Cambridge (GB)

(21) Appl. No.: 19/165,677

(22) PCT Filed: May 9, 2024
(86) PCT No.: PCT/CN2024/091850

§ 371 Date: Sep. 16, 2025

Related U.S. Application Data
(60) Provisional application No. 63/500,929, filed on May 9, 2023.

(51) Int. Cl. H04B 7/06; H04L 5/00

(52) U.S. Cl. CPC H04B 7/0626; H04L 5/0044

(57) ABSTRACT

Various solutions for channel state information-reference signal (CSI-RS) resource configuration applied to sub-band full duplex (SBFD) with respect to an apparatus in mobile communications are described. The apparatus may receive a CSI-RS resource configuration and an SBFD configuration from a network node. The CSI-RS resource configuration includes a plurality of resource blocks (RBs) and the SBFD configuration includes a downlink (DL) sub-band and an uplink (UL) sub-band within a slot. The apparatus may determine that at least one of the RBs is outside the DL sub-band. The apparatus may determine a resource allocation as invalid according to the determination of that the at least one of the RBs is outside the DL sub-band.

### CROSS REFERENCE TO RELATED PATENT APPLICATION(S)

The present disclosure is part of a non-provisional application claiming the priority benefit of U.S. Patent Application No. 63/500,929, filed 9 May 2023, the content of which herein being incorporated by reference in its entirety.

### TECHNICAL FIELD

The present disclosure is generally related to mobile communications and, more particularly, to channel state information-reference signal (CSI-RS) resource configuration applied to sub-band full duplex (SBFD) with respect to apparatus in mobile communications.

### BACKGROUND

Unless otherwise indicated herein, approaches described in this section are not prior art to the claims listed below and are not admitted as prior art by inclusion in this section.

In 5^{th}-generation (5G) New Radio (NR) mobile communications, frequency domain channel state information-reference signal (CSI-RS) resource may be configured as contiguous resource with the starting resource block (RB) and the number of RBs (e.g., parameters of startRB and nrofRBs configured in CSI-FrequencyOccupation information element in 3rd Generation Partnership Project (3GPP) specification.) Moreover, in 5G NR mobile communications, sub-band full duplex (SBFD) technology is introduced, and resource availabilities may be different for SBFD slot (e.g., slot with non-contiguous sub-bands) and non-SBFD slot (e.g., normal slot.)

Hence, regarding CSI-RS resources, especially periodic or semi-persistent CSI-RS resource, the configured and contiguous frequency domain resources may overlap an uplink sub-band of an SBFD slot when the same CSI-RS resource configuration applies to both SBFD slot and non-SBFD slot. However, there is no scheme for dealing with CSI-RS resource that overlaps the uplink sub-band of the SBFD slot.

Accordingly, how to deal with CSI-RS resource that overlaps the uplink sub-band of the SBFD slot become important issues in the newly developed wireless communication network. Therefore, there is a need to provide proper schemes to deal with CSI-RS resource that overlaps the uplink sub-band of the SBFD slot.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to channel state information-reference signal (CSI-RS) resource configuration applied to sub-band full duplex (SBFD) with respect to apparatus in mobile communications.

In one aspect, a method may involve an apparatus receiving a CSI-RS resource configuration and an SBFD configuration from a network node. The CSI-RS resource configuration includes a plurality of resource blocks (RBs) and the SBFD configuration includes a downlink (DL) sub-band and an uplink (UL) sub-band within a slot. The method may also involve the apparatus determining that at least one of the RBs is outside the DL sub-band. The method may further involve the apparatus determining a resource allocation as invalid according to the determination of that the at least one of the RBs is outside the DL sub-band.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, a CSI-RS resource configuration and an SBFD configuration from the network node. The CSI-RS resource configuration includes a plurality of RBs and the SBFD configuration includes a DL sub-band and an UL sub-band within a slot. The processor may also perform operations comprising determining that at least one of the RBs is outside the DL sub-band. The processor may further perform operations comprising determining a resource allocation as invalid according to the determination of that the at least one of the RBs is outside the DL sub-band.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to channel state information-reference signal (CSI-RS) resource configuration applied to sub-band full duplex (SBFD) with respect to apparatus in mobile communications. According to the present disclosure, a number of possible solutions may be implemented separately or jointly. That is, although these possible solutions may be described below separately, two or more of these possible solutions may be implemented in one combination or another.

Regarding to the present disclosure, CSI-RS resource configuration, especially for periodic or semi-persistent CSI-RS resource, may be applied to SBFD. In particular, a user equipment (UE) may consider at least part of allocated resource blocks (RBs) (e.g., RBs allocated based on parameters of startRB and nrofRBs configured in CSI-FrequencyOccupation information element in 3GPP specification) corresponding to a CSI-RS resource configuration as invalid when at least one of the allocated RBs is outside downlink (DL) sub-bands (SBs) (i.e., the allocated RBs partially or fully overlap uplink (UL) SB and/or guard band (GB)).

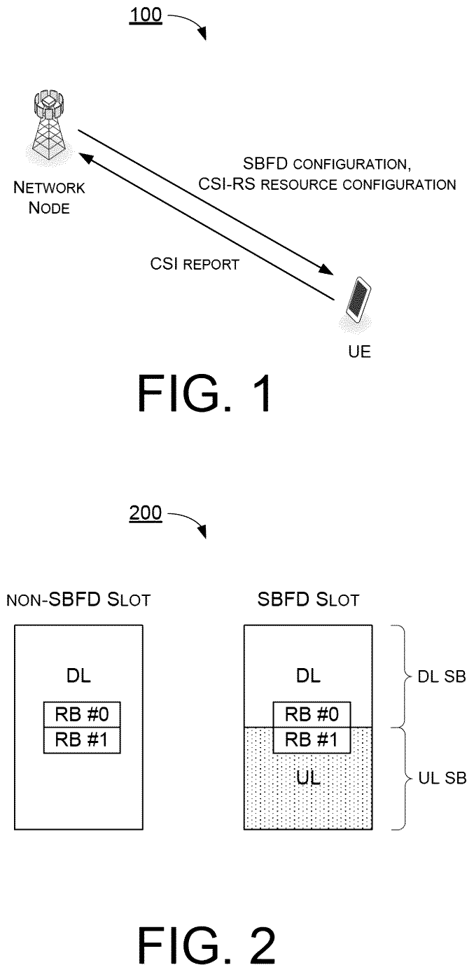

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit a CSI-RS resource configuration and an SBFD configuration to the UE. The CSI-RS resource configuration includes a plurality of RBs and the SBFD configuration includes a DL SB and an UL SB within a slot. In other words, the CSI-RS resource configuration may include parameters indicating the contiguous RBs, and the SBFD configuration may include parameters indicating the DL SB and the UL SB within one slot. After receiving the CSI-RS resource configuration and the SBFD configuration, the UE may determine that whether at least one of the RBs is outside the DL SB. If positive, the UE may determine a resource allocation as invalid according to the determination of that the at least one of the RBs is outside the DL SB.

In some embodiments, the SBFD configuration may include one or more DL SBs and one or more UL SBs within the slot. In other words, the SBFD configuration may include parameters indicating the one or more DL SBs and the one or more UL SBs within one slot. After receiving the CSI-RS resource configuration and the SBFD configuration, the UE may determine that whether at least one of the RBs is outside the one or more DL SBs. If positive, the UE may determine the resource allocation as invalid according to the determination of that the at least one of the RBs is outside the one or more DL SBs.

FIG. 2 illustrates an example scenario 200 under schemes in accordance with implementations of the present disclosure. In some embodiments, the SBFD configuration may include the parameters indicating one DL SB and one UL SB within one SBFD slot. The CSI-RS resource configuration may include the parameters indicating RB #0 and RB #1 over non-SBFD slot (e.g., normal DL slot) and SBFD slot. SBFD slot may contain both DL resources and UL resources in frequency domain (i.e., DL SB(s) and UL SB(s),) and each non-SBFD slot may contain only DL resources in frequency domain. In these embodiments, after receiving the SBFD configuration and the CSI-RS resource configuration, the UE may determine that RB #1 is outside the DL SB. The UE may then determine the resource allocation as invalid.

In some implementations, the resource allocation determined as invalid may include all RBs of the CSI-RS resource configuration. More specifically, after determining that RB #1 is outside the DL SB, the UE may then determine all RBs (i.e., RB #0 and #1) of the CSI-RS resource configuration (e.g., the entire CSI-RS resource configuration) as invalid.

In addition, in these implementations, the UE may skip/invalidate/cancel/stop a procedure of CSI measurement and reporting corresponding to the RBs of the CSI-RS resource configuration. In other words, the UE may determine not to perform the procedure of CSI measurement and reporting with any CSI-RS resource provided in the CSI-RS resource configuration. The UE may consider the CSI-RS resource configuration as an error case.

In some implementations, the resource allocation determined as invalid may include the RBs in the slot having the DL SB and the UL SB. In other words, the resource allocation determined as invalid may include the RBs in the SBFD slot. More specifically, after determining that RB #1 is outside the DL SB, the UE may then determine the SBFD slot with RB #1 outside the DL SB as invalid. In some cases, applying the CSI-RS resource configuration to the non-SBFD slot (e.g., normal DL slot) may remain valid.

In addition, in these implementations, the UE may skip/invalidate/cancel/stop a procedure of CSI measurement and reporting corresponding to the RBs (i.e., RB #0and #1) in the SBFD slot. In other words, the UE may determine not to perform the procedure of CSI measurement and reporting for the SBFD slot when the configured RBs partially or fully overlap the UL SB (or a GB.)

In some implementations, the resource allocation determined as invalid may include the at least one of the RBs (i.e., RB #1) outside the DL SB. More specifically, after determining that RB #1 is outside the DL SB, the UE may then determine RB #1 as invalid.

In addition, in these implementations, the UE may perform a procedure of CSI measurement and reporting corresponding to allocated RB(s) within the DL SB (i.e., RB #0 within the DL SB.) In other words, the UE may perform the procedure of CSI measurement and reporting using the allocated RB #0 that falls within (or overlaps) the DL SB.

In some implementations, the at least one of the RBs (i.e., RB #1) is determined outside the DL SB for at least one CSI-RS resource within a CSI-RS resource set, and the resource allocation determined as invalid may include the CSI-RS set. More specifically, after determining that RB #1 for the at least one CSI-RS resource within the CSI-RS resource set is outside the DL SB, the UE may then determine the whole CSI-RS set as invalid.

In some implementations, the at least one of the RBs (i.e., RB #1) is determined outside the DL SB for at least one first CSI-RS resource within a CSI-RS resource set, and the resource allocation determined as invalid may include the at least one first CSI-RS resource with the at least one of the RBs outside the DL SB. More specifically, after determining that RB #1 for the at least one CSI-RS resource within the CSI-RS resource set is outside the DL SB, the UE may then determine the at least one first CSI-RS resource with RB #1 as invalid. In some cases, at least one second CSI-RS resource other than the at least one CSI-RS resource in the CSI-RS resource set may be determined as valid.

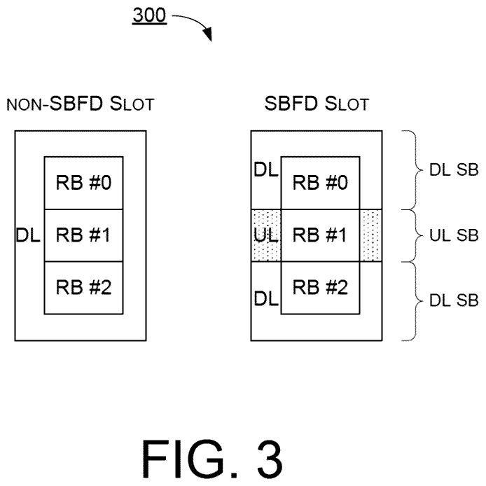

FIG. 3 illustrates an example scenario 300 under schemes in accordance with implementations of the present disclosure. In some embodiments, the SBFD configuration may include the parameters indicating two DL SBs and one UL SB within one SBFD slot. The UL SB may be between the DL SBs. The CSI-RS resource configuration may include the parameters indicating RB #0, RB #1 and RB #2 over non-SBFD slot and SBFD slot. In these embodiments, after receiving the SBFD configuration and the CSI-RS resource configuration, the UE may determine that RB #1 is outside the DL SBs. The UE may then determine the resource allocation as invalid.

In some implementations, the resource allocation determined as invalid may include all RBs of the CSI-RS resource configuration. More specifically, after determining that RB #1 is outside the DL SBs, the UE may then determine all RBs (i.e., RB #0, #1 and #2) of the CSI-RS resource configuration (e.g., the entire CSI-RS resource configuration) as invalid.

In addition, in these implementations, the UE may skip/invalidate/cancel/stop to perform a procedure of CSI measurement and reporting corresponding to the the RBs of the CSI-RS resource configuration. In other words, the UE may determine not to perform the procedure of CSI measurement and reporting with any CSI-RS resource provided in the CSI-RS resource configuration. The UE may consider the CSI-RS resource configuration as an error case.

In some implementations, the resource allocation determined as invalid may include the RBs in the slot having the DL SB and the UL SB. In other words, the resource allocation determined as invalid may include the RBs in the SBFD slot. More specifically, after determining that RB #1 is outside the DL SBs, the UE may then determine the SBFD slot with RB #1 outside the DL SBs as invalid. In some cases, applying the CSI-RS resource configuration to the non-SBFD slot (i.e., normal slot) may remain valid.

In addition, in these implementations, the UE may skip/invalidate/cancel/stop a procedure of CSI measurement and reporting corresponding to the RBs (i.e., RB #0, #1 and #2) in the SBFD slot. In other words, the UE may determine not to perform the procedure of CSI measurement and reporting for the SBFD slot when the configured RBs partially or fully overlap the UL SB (or a GB.)

In some implementations, the resource allocation determined as invalid may include the at least one of the RBs (i.e., RB #1) outside the DL SBs. More specifically, after determining that RB #1 is outside the DL SBs, the UE may then determine RB #1 as invalid.

In addition, in these implementations, the UE may perform a procedure of CSI measurement and reporting corresponding to allocated RB(s) within the DL SBs (i.e., RB #0 and #2 within the DL SBs.) In other words, the UE may perform the procedure of CSI measurement and reporting using the allocated RB #0 and #2 that fall within (or overlaps) the DL SBs.

In some implementations, the at least one of the RBs (i.e., RB #1) is determined outside the DL SBs for at least one CSI-RS resource within a CSI-RS resource set, and the resource allocation determined as invalid may include the CSI-RS set. More specifically, after determining that RB #1 for the at least one CSI-RS resource within the CSI-RS resource set is outside the DL SBs, the UE may then determine the whole CSI-RS set as invalid.

In some implementations, the at least one of the RBs (i.e., RB #1) is determined outside the DL SBs for at least one first CSI-RS resource within a CSI-RS resource set, and the resource allocation determined as invalid may include the at least one first CSI-RS resource with the at least one of the RBs outside the DL SBs. More specifically, after determining that RB #1 for the at least one CSI-RS resource within the CSI-RS resource set is outside the DL SBs, the UE may then determine the at least one first CSI-RS resource with RB #1 as invalid. In some cases, at least one second CSI-RS resource other than the at least one CSI-RS resource in the CSI-RS resource set may be determined as valid.

In some implementations, the SBFD configuration may be included in a layer-1 signaling (e.g., physical layer signaling). In other words, the SBFD configuration may be transmitted via the layer-1 signaling. The layer-1 signaling may comprise, for example, a downlink control information (DCI.)

In some embodiments, the SBFD configuration may be included in a higher layer signaling. In other words, the SBFD configuration may be transmitted via the higher layer signaling. The higher layer signaling may comprise, for example, a radio resource control (RRC) signaling or a medium access control (MAC) control element (CE.)

### Illustrative Implementations

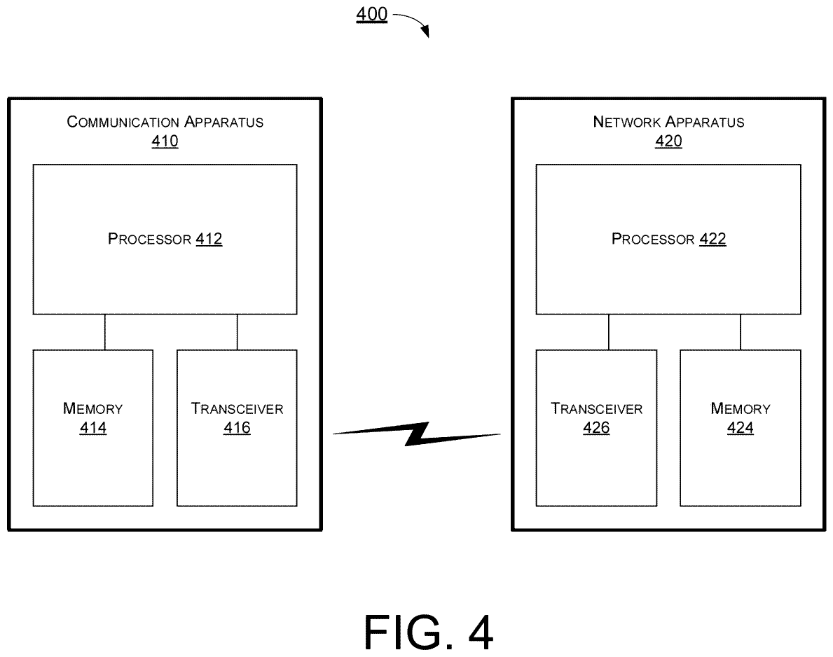

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to CSI-RS resource configuration applied to SBFD with respect to user equipment and network apparatus in mobile communications, including scenarios/schemes described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including autonomous reliability enhancements in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may receive, by the transceiver 416, a CSI-RS resource configuration and an SBFD configuration from network apparatus 420. The CSI-RS resource configuration includes a plurality of RBs and the SBFD configuration includes a DL SB and an UL SB within a slot. Processor 412 may determine that at least one of the RBs is outside the DL SB. Processor 412 may determine a resource allocation as invalid according to the determination of that the at least one of the RBs is outside the DL SB.

In some implementations, the resource allocation includes all the RBs of the CSI-RS resource configuration.

In some implementations, processor 412 may determine not to perform a procedure of CSI measurement and reporting corresponding to the the RBs of the CSI-RS resource configuration.

In some implementations, the resource allocation includes the RBs in the slot having the DL SB and the UL SB.

In some implementations, processor 412 may determine not to perform a procedure of CSI measurement and reporting corresponding to the RBs in the slot having the DL SB and the UL SB.

In some implementations, the resource allocation includes the at least one of the RBs outside the DL SB.

In some implementations, processor 412 may a procedure of CSI measurement and reporting corresponding to at least one of allocated RBs within the DL SB.

In some implementations, the at least one of the RBs is determined outside the DL SB for at least one CSI-RS resource within a CSI-RS resource set, and the resource allocation includes the CSI-RS resource set.

In some implementations, the at least one of the RBs is determined outside the DL SB and for at least one first CSI-RS resource within a CSI-RS resource set, and the resource allocation includes the at least one first CSI-RS resource with the at least one of the RBs outside the DL SB.

In some implementations, at least one second CSI-RS resource other than the at least one CSI-RS resource in the CSI-RS resource set is determined as valid.

### Illustrative Processes

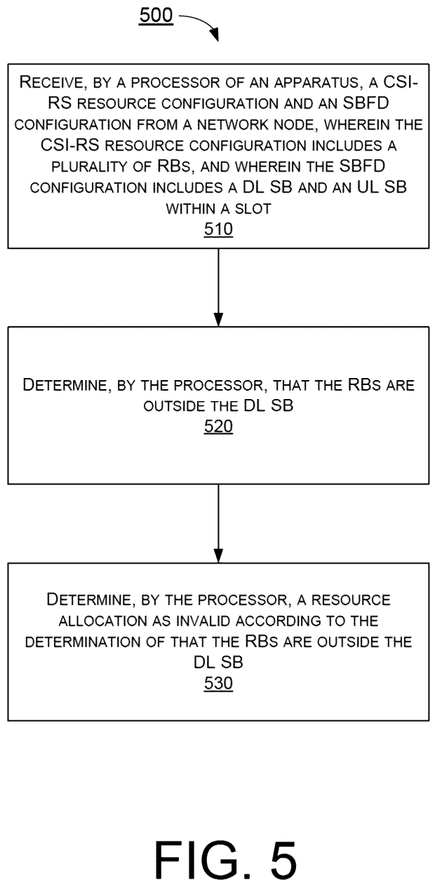

FIG. 5 illustrates an example process 500 in accordance with an implementation of the present disclosure. Process 500 may be an example implementation of above scenarios/schemes, whether partially or completely, with respect to CSI-RS resource configuration applied to SBFD of the present disclosure. Process 500 may represent an aspect of implementation of features of communication apparatus 410. Process 500 may include one or more operations, actions, or functions as illustrated by one or more of blocks 510 and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 1410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 receiving a CSI-RS resource configuration and an SBFD configuration from a network node. The CSI-RS resource configuration includes a plurality of RBs and the SBFD configuration includes a DL SB and an UL SB within a slot. Process 500 may proceed from block 510 to block 520.

At block 520, process 500 may involve processor 412 determining that at least one of the RBs is outside the DL SB. Process 500 may proceed from block 520 to block 530.

At block 520, process 500 may involve processor 412 determining a resource allocation as invalid according to the determination of that the at least one of the RBs is outside the DL SB.

In some implementation, the resource allocation may include all the RBs of the CSI-RS resource configuration, and process 500 may involve processor 412 determining not to perform a procedure of CSI measurement and reporting corresponding to the the RBs of the CSI-RS resource configuration.

In some implementation, the resource allocation may include the RBs in the slot having the DL SB and the UL SB, and process 500 may involve processor 412 determining not to perform a procedure of CSI measurement and reporting corresponding to the RBs in the slot having the DL SB and the UL SB.

In some implementation, the resource allocation may include the at least one of the RBs outside the DL SB, and process 500 may involve processor 412 performing a procedure of CSI measurement and reporting corresponding to at least one of allocated RBs within the DL SB.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a channel state information-reference signal (CSI-RS) resource configuration and a sub-band full duplex (SBFD) configuration from a network node, wherein the CSI-RS resource configuration includes a plurality of resource blocks (RBs), and wherein the SBFD configuration includes a downlink (DL) sub-band and an uplink (UL) sub-band within a slot;
determining, by the processor, that the RBs are outside the DL sub-band; and
determining, by the processor, a resource allocation as invalid according to the determination of that the RBs are outside the DL sub-band.

2. The method of claim 1, wherein the resource allocation includes all the RBs of the CSI-RS resource configuration.

3. The method of claim 2, further comprising:
determining, by the processor, not to perform a procedure of CSI measurement and reporting corresponding to the the RBs of the CSI-RS resource configuration.

4. The method of claim 1, wherein the resource allocation includes the RBs in the slot having the DL sub-band and the UL sub-band.

5. The method of claim 4, further comprising:
determining, by the processor, not to perform a procedure of CSI measurement and reporting corresponding to the RBs in the slot having the DL sub-band and the UL sub-band.

6. The method of claim 1, wherein the resource allocation includes the RBs outside the DL sub-band.

7. The method of claim 6, further comprising:
performing, by the processor, a procedure of CSI measurement and reporting corresponding to at least one of allocated RBs within the DL sub-band.

8. The method of claim 1, wherein the RBs are determined outside the DL sub-band for at least one CSI-RS resource within a CSI-RS resource set, and wherein the resource allocation includes the CSI-RS resource set.

9. The method of claim 1, wherein the RBs are determined outside the DL sub-band for at least one first CSI-RS resource within a CSI-RS resource set, and wherein the resource allocation includes the at least one first CSI-RS resource with the RBs outside the DL sub-band.

10. The method of claim 9, wherein at least one second CSI-RS resource other than the at least one CSI-RS resource in the CSI-RS resource set is determined as valid.

11. An apparatus, comprising:
a transceiver which, during operation, wirelessly communicates with a network node; and
a processor communicatively coupled to the transceiver such that, during operation, the processor performs operations comprising:
receiving, via the transceiver, a channel state information-reference signal (CSI-RS) resource configuration and a sub-band full duplex (SBFD) configuration from the network node, wherein the CSI-RS resource configuration includes a plurality of resource blocks (RBs), and wherein the SBFD configuration includes a downlink (DL) sub-band and an uplink (UL) sub-band within a slot;
determining that at least one of the RBs is outside the DL sub-band; and
determining a resource allocation as invalid according to the determination of that the at least one of the RBs is outside the DL sub-band.

12. The apparatus of claim 11, wherein the resource allocation includes all the RBs of the CSI-RS resource configuration.

13. The apparatus of claim 12, wherein, during operation, the processor further performs operations comprising:
determining not to perform a procedure of CSI measurement and reporting corresponding to the the RBs of the CSI-RS resource configuration.

14. The apparatus of claim 11, wherein the resource allocation includes the RBs in the slot having the DL sub-band and the UL sub-band.

15. The apparatus of claim 14, wherein, during operation, the processor further performs operations comprising:
determining not to perform a procedure of CSI measurement and reporting corresponding to the RBs in the slot having the DL sub-band and the at least one UL sub-band.

16. The apparatus of claim 11, wherein the resource allocation includes the at least one of the RBs outside the DL sub-band.

17. The apparatus of claim 16, wherein, during operation, the processor further performs operations comprising:
performing a procedure of CSI measurement and reporting corresponding to at least one of allocated RBs within the DL sub-band.

18. The apparatus of claim 11, wherein the at least one of the RBs is determined outside the DL sub-band for at least one CSI-RS resource within a CSI-RS resource set, and wherein the resource allocation includes the CSI-RS resource set.

19. The apparatus of claim 11, wherein the at least one of the RBs is determined outside the DL sub-band for at least one first CSI-RS resource within a CSI-RS resource set, and wherein the resource allocation includes the at least one first CSI-RS resource with the at least one of the RBs outside the DL sub-band.

20. The apparatus of claim 19, wherein at least one second CSI-RS resource other than the at least one CSI-RS resource in the CSI-RS resource set is determined as valid.
